(19) United States
(12) Patent Application Publication
(10) Pub. No.: US 2021/0288314 A1
(43) Pub. Date: Sep. 16, 2021

(54) CARBON- AND GRAPHENE-PROTECTED CATHODE ACTIVE MATERIALS FOR LITHIUM-ION CELLS

(71) Applicant: Global Graphene Group, Inc., Dayton, OH (US)

(72) Inventors: Mingrui Liu, Dayton, OH (US); Hao-Hsun Chang, Centerville, OH (US); Aruna Zhamu, Springboro, OH (US); Bor Z. Jang, Centerville, OH (US)

(21) Appl. No.: 16/817,883

(22) Filed: Mar. 13, 2020

(51) Int. Cl. H01M 4/36; H01M 4/505; H01M 4/525; H01M 4/587; H01M 4/62; H01M 10/0525

(52) U.S. Cl. CPC H01M 4/366; H01M 4/505; H01M 4/525; H01M 2004/028; H01M 4/625; H01M 10/0525; H01M 4/587

(57) ABSTRACT

Provided is a graphene-embraced particulate (a secondary particle) for use as a lithium-ion battery cathode active material. The particulate comprises a core of one or a plurality of particles of a cathode active material embraced or encapsulated by a shell comprising multiple graphene sheets, wherein the cathode active material is selected from the group of lithium cobalt metal oxides having a general formula of LiₓNi_{y}Co_{z}M_{w}O₂, M is selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof, and x ranges from 0 to 1.2, the sum of y+z+w ranges from 0.8 to 1.2, w range from 0 to 0.5, y and z are both greater than zero, and the ratio z/y ranges from 0 to 0.5.

### FIELD

The present disclosure relates generally to the field of lithium-ion batteries and, in particular, to graphene-protected lithium multiple transition metals-based cathode active materials for lithium-ion batteries.

### BACKGROUND

Commonly used cathode active materials for lithium-ion batteries include lithium nickel manganese cobalt oxide (“NMC” or “NCM”, LiNiₓMn_{y}Co_{z}O₂), lithium nickel cobalt aluminum oxide (“NCA”, LiNiCoAlO₂), lithium manganese oxide (“LMO”, LiMn₂O₄), lithium iron phosphate (“LFP”, LiFePO₄), and lithium cobalt oxide (LiCoO₂, “LCO”), etc.

Due to extremely poor electrical conductivity of all cathode (positive electrode) active materials in a lithium-ion, lithium metal, or lithium-sulfur cell, a conductive additive (e.g. carbon black, fine graphite particles, expanded graphite particles, or their combinations), typically in the amount of 5%-20%, must be added into the electrode. In the case of a lithium-sulfur cell, a carbon amount as high as 50% by weight is used as a conductive support for sulfur in the cathode. However, the conductive additive is not an electrode active material (i.e. it is not capable of reversibly storing lithium ions). The use of a non-active material means that the relative proportion of an electrode active material is reduced or diluted. For instance, the incorporation of 7% by weight of PVDF as a binder and 8% of carbon black as a conductive additive in a cathode would mean that the maximum amount of the cathode active material (e.g., lithium cobalt oxide) is only 85%, effectively reducing the total lithium ion storage capacity. Since the specific capacities of the more commonly used cathode active materials are already very low (140-200 mAh/g), this problem is further aggravated if a significant amount of non-active materials (e.g. a conductive additive) is used to dilute the concentration of the active material.

State-of-the-art carbon black (CB) and other similar carbon materials (e.g. acetylene black), as a conductive additive, have several drawbacks:
(1) CBs are typically available in the form of aggregates of multiple primary particles that are typically spherical in shape. Due to this geometric feature (largest dimension-to-smallest dimension ratio or aspect ratio ˜1) and the notion that CBs are a minority phase dispersed as discrete particles in an electrically insulating matrix (e.g. lithium cobalt oxide and lithium iron phosphate), a large amount of CBs is required to reach a percolation threshold where the CB particles are combined to form a 3-D network of electron-conducting paths.
(2) CBs themselves have a relatively low electrical conductivity and, hence, the resulting electrode remains to be of relatively low conductivity even when the percolation threshold is reached. A relatively high proportion of CBs (far beyond the percolation threshold) must be incorporated in the cathode to make the resulting composite electrode reasonably conducting.
(3) CBs are not lithium ion-conducting and do not provide any other useful functions to the operation of a lithium-ion battery.

Clearly, an urgent need exists for a more effective electrically conductive additive material. Preferably, this electrically conductive additive is also of high thermal conductivity. Such a thermally conductive additive would be capable of dissipating the heat generated from the electrochemical operation of the Li-ion battery, thereby increasing the reliability of the battery and decreasing the likelihood that the battery will suffer from thermal runaway and rupture. With a high electrical conductivity, there would be no need to add a high proportion of conductive additives.

There have been several attempts to use other carbon nano-materials than carbon black (CB) or acetylene black (AB) as a conductive additive for certain cathode materials of a lithium battery. These include carbon nano-tubes (CNTs), vapor-grown carbon nano-fibers (VG-CNFs), and simple carbon coating on the surface of cathode active material particles. The result has not been satisfactory and hence, as of today, carbon black and artificial graphite particles are practically the only two types of cathode conductive additives widely used in lithium ion battery industry. The reasons are beyond just the obvious high costs of both CNTs and VG-CNFs. The difficulty in disentangling CNTs and VG-CNFs and uniformly dispersing them in a liquid or solid medium has been an impediment to the more widespread utilization of these expensive materials as a conductive additive. Additionally, the production of both CNTs and VG-CNFs normally require the use of a significant amount of transition metal nano particles as a catalyst. It is difficult to remove or impossible to totally remove these transition metal particles, which can have adverse effect on the cycling stability of a lithium metal.

Thus, an urgent need exists to have a conductive material that provides a 3D network of electron-conducting pathways without the use of an excessive amount of conductive additives that are non-active materials (that adds weight and volume to the battery without providing additional capacity of storing lithium ions).

Further, such conductive materials preferably are also effective in imparting other useful functions to a lithium-ion battery, such as preventing direct contact between a liquid electrolyte and a transition metal in a cathode active material for the purpose of reducing transition metal-induced decomposition of the electrolyte.

### SUMMARY

It may be noted that the word “electrode” herein refers to either an anode (negative electrode) or a cathode (positive electrode) of a battery. These definitions are also commonly accepted in the art of batteries or electrochemistry.

The present disclosure provides a graphene-embraced particulate (a secondary particle) for use as a lithium-ion battery cathode active material, the particulate comprising a core of one or a plurality of particles of a cathode active material embraced or encapsulated by a shell comprising multiple graphene sheets, wherein the cathode active material is selected from the group of lithium cobalt metal oxides having a general formula of LiₓNi_{y}Co_{z}M_{w}O₂, where M is selected from consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof and x ranges from 0 to 1.2 (it can be varied within this range by electrochemical insertion and extraction), the sum of y+z+w ranges from 0.8 to 1.2 (in a particular instance the sum of y+z+w was equal to 1), w ranges from 0 to 0.5, y and z are both greater than zero, and the ratio z/y ranges from 0 to 0.5 (in one instance the ratio of z/y was 0.1). A particularly desired class of cathode materials contains M being selected from Be, Mg, Ca and their various combinations and their combinations with Mn (manganese) and/or Al (aluminum). It may be noted that the lithium-ion cell has a higher specific capacity when w is from above 0 to about 0.25 and has a more stable cycling behavior if w is from 0.25 to 0.5.

In some embodiments of the general formula of LiₓNi_{y}Co_{z}M_{w}O₂, M comprises multiple elements selected from selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof. In a non-limiting example, M contains BeₐMg_{b}Ca_{c}, where a +b+c=w. M may be a in the form of M⁰ₐ, M⁰ₐM¹_{b}, or M⁰ₐM¹_{b}M²_{c}, where M⁰ M¹ and M² are elements selected from the group consisting of aluminum (Al), titanium (Ti), tungsten (W), chromium (Cr), molybdenum (Mo), magnesium (Mg), beryllium (Be), calcium (Ca), tantalum (Ta), and silicon (Si), wherein a +b+c=w.

The graphene sheets may be in an amount from 0.01% to 20% by weight (preferably from 0.1% to 10%), based on the total weight of the particulate. In some embodiments, the particulate is spherical or ellipsoidal in shape. The particulate preferably has an electrical conductivity greater than 10⁻⁴ S/cm, more preferably greater than 10⁻² S/cm.

The graphene sheets preferably comprise single-layer graphene or few-layer graphene, wherein the few-layer graphene is defined as a graphene sheet or platelet formed of 2-10 graphene planes. There are multiple single-layer or few-layer graphene sheets/platelets wrapping around one primary particle or a few primary particles of the cathode active material clustered together. In some embodiments, the graphene material is selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

In the graphene-embraced particulate, the core may further comprise a carbon material in electronic contact with said one or a plurality of particles of a cathode active material.

The carbon material in the core may be selected from an amorphous carbon coating deposited on surfaces of the one or a plurality of particles of a cathode active material, or a carbon particle, activated carbon, graphite flake, graphene sheet (internal graphene sheet), carbon nanotube, carbon nano-fiber, carbon black, acetylene black, carbonized resin, carbon fiber, graphite fiber, pitch, coke, or a combination thereof.

The carbon particle may include pitch-derived soft carbon (a soft carbon is a carbon that can be graphitized at a temperature higher than 2,500° C.) or pitch-derived hard carbon (a carbon that cannot be graphitized at a temperature higher than 2,500° C.).

The carbonized resin or polymeric carbon is obtained from pyrolyzation of a polymer selected from the group consisting of phenol-formaldehyde, polyacrylonitrile, styrene-based polymers, cellulosic polymers, epoxy resins, and combinations thereof.

The cathode active material particles in the particulate preferably have a dimension smaller than 1 μm, more preferably smaller than 100 nm.

The present disclosure also provides a carbon-embraced particulate for use as a lithium-ion battery cathode active material. The particulate comprises a core of one or a plurality of particles of a cathode active material embraced or encapsulated by a shell comprising an encapsulating carbon material, wherein the cathode active material is selected from the group of lithium cobalt metal oxides having a general formula of LiₓNi_{y}Co_{z}M_{w}O₂, where M is selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof and x is from 0 to 1.2,), the sum of y+z+w ranges from 0.8 to 1.2 (in a particular instance the sum of y+z+w was equal to 1), w is from 0 to 0.5, y and z are both greater than zero, and the ratio z/y ranges from 0 to 0.5.

In some embodiments of the general formula of LiₓNi_{y}Co_{z}M_{w}O₂, M comprises multiple elements selected from selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof. In a non-limiting example, M contains BeₐMg_{b}Ca_{c}, where a +b+c=w. M may be a in the form of M⁰ₐ, M⁰ₐM¹_{b}, or M⁰ₐM¹_{b}M²_{c}, where M⁰ M¹ and M² are elements selected from the group consisting of aluminum (Al), titanium (Ti), tungsten (W), chromium (Cr), molybdenum (Mo), magnesium (Mg), beryllium (Be), calcium (Ca), tantalum (Ta), and silicon (Si), wherein a +b+c=w.

The encapsulating carbon material of the carbon-embraced particulate may be selected from amorphous carbon, chemical vapor deposition carbon, physical vapor deposition carbon, sputtering carbon, carbonized resin or polymeric carbon, or a combination thereof. The core of the carbon-embraced particulate may further comprise a carbon or graphitic material selected from a carbon particle, graphite flake, graphene sheet, carbon nanotube, carbon nano-fiber, carbon black, acetylene black, carbonized resin, or a combination thereof.

The disclosure also provides a powder mass of multiple particulates as defined above. Also provided is a lithium battery cathode electrode containing a mass of multiple particulates of this type and optional conductive filler (typically 0-15% by weight) and optional binder (typically 0-15% by weight). In some embodiments, the disclosure provides a lithium battery containing such a cathode electrode.

Also provided is a process for producing the aforementioned graphene-embraced particulate, the process comprising:
a. Dispersing multiple sheets of a graphene material and a precursor to a cathode active material in a liquid medium to form a suspension;
b. drying the suspension using a procedure of spray-drying, spray-pyrolysis, fluidized-bed drying, ultrasonic spraying, aerosol spraying, or liquid atomization to form a precursor particulate containing graphene sheets and particles or coating of the cathode active material precursor; and
c. thermally and/or chemically converting the precursor particulate to form the graphene-embraced particulate.

The step of converting may comprise a procedure of chemically or thermally reducing said graphene precursor to reduce or eliminate oxygen content and other non-carbon elements of said graphene precursor.

The disclosure also provides a process for producing a mass of graphene-embraced particulates as defined earlier, the process comprising:
a) mixing multiple particles of a graphitic material and multiple primary particles of the solid cathode active material and optional ball-milling media to form a mixture in an impacting chamber of an energy impacting apparatus (preferably the graphitic material has never been previously intercalated, oxidized, or exfoliated and said impacting chamber contains therein no previously produced isolated graphene sheets);
b) operating the energy impacting apparatus with a frequency and an intensity for a length of time sufficient for peeling off graphene sheets from the particles of graphitic material and transferring the peeled graphene sheets to surfaces of the primary particles of the solid cathode active material and fully embrace or encapsulate the primary particles to produce graphene-embraced or graphene-encapsulated primary particles of the cathode active material inside the impacting chamber; and
c) recovering the graphene-embraced or graphene-encapsulated primary particles from the impacting chamber.

This is a strikingly simple, fast, scalable, environmentally benign, and cost-effective process for producing graphene-embraced (graphene-encapsulated) particulates or secondary particles containing a core of one or a plurality of particles of a cathode active material encapsulated or embraced by an encapsulating shell comprising multiple graphene sheets.

This process entails producing single-layer or few layer graphene sheets directly from a graphitic or carbonaceous material (a graphene source material) and immediately transferring these isolated (peeled-off) graphene sheets onto surfaces of the cathode active material particles to form graphene-embraced or graphene-encapsulated primary particles of cathode active material. In an embodiment, the graphitic material or carbonaceous material has never been previously intercalated, oxidized, or exfoliated and does not include previously produced isolated graphene sheets.

In certain specific embodiments, this disclosure provides a self-embracing or self-encapsulating method of producing graphene-embraced or graphene-encapsulated primary particles of a cathode active material directly from a graphitic material. In certain embodiments, the method comprises:
a) mixing multiple particles of a graphitic material and multiple primary particles of a solid anode active material to form a mixture in an impacting chamber of an energy impacting apparatus, wherein preferably the graphitic material has never been intercalated, oxidized, or exfoliated and does not include previously produced isolated graphene sheets. The impacting chamber contains no ball-milling media (i.e., the solid electrode active material particles themselves serve as an impacting media and no externally added ball-milling media is needed or involved);
b) operating the energy impacting apparatus with a frequency and an intensity for a length of time sufficient for transferring graphene sheets from the particles of graphitic material to surfaces of the solid electrode active material particles to produce a graphene-embraced electrode active material inside the impacting chamber (i.e., solid electrode active material particles impinge upon surfaces of graphitic material particles, peeling off graphene sheets therefrom, and naturally allowing the peeled-off graphene sheets to fully wrap around or embrace the solid electrode active material particles); and
c) recovering the graphene-embraced primary particles of cathode active material from the impacting chamber (this can be as simple as removing the cap to the impacting chamber and removing the particles of graphene-embraced electrode active material).

The method further comprises a step of incorporating particulates of graphene-embraced or graphene-encapsulated anode active material into a battery electrode.

In some embodiments, prior to the instant “graphene direct transfer and embracing process,” the particles of solid electrode active material contain particles pre-coated with a coating layer of a conductive material selected from carbon, pitch, carbonized resin, a conductive polymer, a conductive organic material, a metal coating, a metal oxide shell, or a combination thereof. The coating layer thickness is preferably in the range from 1 nm to 20 μm, preferably from 10 nm to 10 μm, and further preferably from 100 nm to 1 μm.

In some embodiments, the primary particles of solid electrode active material contain particles that are pre-coated with a carbon precursor material selected from a coal tar pitch, petroleum pitch, meso-phase pitch, polymer, organic material, or a combination thereof so that the carbon precursor material resides between surfaces of the solid electrode active material particles and the embracing graphene sheets, and the method further contains a step of heat-treating the graphene-embraced electrode active material to convert the carbon precursor material to a carbon materials, wherein the graphene sheets, and the carbon material is coated on the surfaces of solid electrode active material particles and/or chemically bonds the graphene sheets together.

In some embodiments, the method further comprises a step of exposing the graphene-embraced primary particles of cathode active material to a liquid or vapor of a conductive material that is conductive to electrons and/or ions of lithium, sodium, magnesium, aluminum, or zinc.

In some embodiments, the electrode active material particles include powder, flakes, beads, pellets, spheres, wires, fibers, filaments, discs, ribbons, or rods, having a diameter or thickness from 10 nm to 20 μm. Preferably, the diameter or thickness is from 1 μm to 100 μm.

In the invented method, the graphitic material may be selected from natural graphite, synthetic graphite, highly oriented pyrolytic graphite, graphite fiber, graphitic nano-fiber, graphite fluoride, chemically modified graphite, meso-carbon micro-bead, partially crystalline graphite, or a combination thereof.

The method energy impacting apparatus may be a vibratory ball mill, planetary ball mill, high energy mill, basket mill, agitator ball mill, cryogenic ball mill, micro ball mill, tumbler ball mill, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, or resonant acoustic mixer. Optionally, milling media may be added into the impacting chamber and later removed upon completion of the graphene-encapsulated primary particle production procedure.

The procedure of operating the energy impacting apparatus may be conducted in a continuous manner using a continuous energy impacting device

The present disclosure also provides a mass of graphene-embraced secondary particles of solid cathode active material produced by the aforementioned method, wherein the graphene proportion is from 0.01% to 20% by weight based on the total weight of graphene and solid active material particles combined.

Also provided is a battery cathode electrode containing the graphene-embraced secondary particles produced according to the presently invented method, and a battery containing such an electrode.

It may be noted that the graphene production step per se (peeling off graphene sheets directly from graphite particles and immediately or concurrently transferring these graphene sheets to electrode active material particle surfaces) is quite surprising, considering the fact that prior researchers and manufacturers have focused on more complex, time intensive and costly methods to create graphene in industrial quantities. In other words, it has been generally believed that chemical intercalation and oxidation is needed to produce bulk quantities of isolated graphene sheets (NGPs). The present disclosure defies this expectation in many ways:
1. Unlike the chemical intercalation and oxidation (which requires expansion of inter-graphene spaces, further expansion or exfoliation of graphene planes, and full separation of exfoliated graphene sheets), the instant method directly removes graphene sheets from a source graphitic material and transfers these graphene sheets to surfaces of electrode active material particles. No undesirable chemicals (e.g. sulfuric acid and nitric acid) are used.
2. Unlike oxidation and intercalation, pristine graphene sheets can be transferred onto the electrode active material. The sheets being free of oxidation damage allow the creation of graphene-encapsulated particle products with higher electrical and thermal conductivity.
3. Contrary to common production methods, a washing process requiring substantial amounts of water or solvent is not needed
4. Unlike bottom up production methods capable of producing small graphene sheets, large graphene sheets can be produced with the instant method.
5. Unlike CVD and solution-based metalorganic production methods, elevated temperatures are not required to reduce graphene oxide to graphene and metalorganic compounds to pure metal. This greatly reduces the opportunity for undesirable diffusion of carbon into the electrode active material.
6. Unlike CVD and solution-based metalorganic production methods, this process is amenable to almost any electrode active material. The electrode active material does not need to be a compatible “template” or catalyst, as is required for the CVD process.
7. This direct transfer process does not require the use of externally added ball milling media (such as zirconia beads or plastic beads). The electrode active material particles themselves are the graphene-peeling media. The presence of extra milling media is optional.
8. This method allows the creation of overlapping graphene sheets, in some way analogous to fish scale, which slide over one another when the primary particle expands or shrinks, thereby preventing repeated direct exposure of the primary particle surface and the solid-electrolyte interface (SEI) coated thereon to the surrounding electrolyte and, hence, eliminating repeated breakage and re-formation of SEI during repeated charges/discharges. Presumably due to this main reason, the battery cell containing secondary particles featuring such a multi-level graphene protection strategy usually exhibit an exceptionally long cycle life.
9. The present disclosure is amenable to industrial scale production in a continuous energy impact device.

### BRIEF DESCRIPTION OF THE DRAWINGS

FIG. 1 A flow chart showing the most commonly used prior art process of producing highly oxidized graphene sheets (or nano graphene platelets, NGPs) that entails chemical oxidation/intercalation, rinsing, and high-temperature exfoliation procedures.

FIG. 2 A diagram showing the presently invented process for producing graphene-embraced or graphene-encapsulated cathode active material particles via an energy impacting apparatus.

FIG. 3 A diagram showing the presently invented process for producing graphene-embraced cathode active material particles via a continuous ball mill.

FIG. 4 X-ray diffraction curves of certain cathode active materials herein produced.

FIG. 5 SEM image of certain cathode active material particles.

FIG. 6 Charge-discharge curves of a LiNi_{y}Co_{z}Mg_{w}O₂ material.

FIG. 7 Discharge capacities of a LiNi_{y}Co_{z}Mg_{w}O₂ material and those of a conventional NCM-622 cathode material plotted as a function of charge/discharge cycle number.

### DETAILED DESCRIPTION OF PREFERRED EMBODIMENTS

The present disclosure provides a graphene-embraced and/or carbon-embraced particulate (a secondary particle) for use as a lithium-ion battery cathode active material. In certain embodiments, the particulate comprises a core of one or a plurality of particles of a cathode active material embraced or encapsulated by a shell comprising multiple graphene sheets and/or carbon, wherein the cathode active material is selected from the group of lithium cobalt metal oxides having a general formula LiₓNi_{y}Co_{z}M_{w}O₂, where M is selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof and x is from 0 to 1.2 (can be varied within this range by electrochemical insertion and extraction), the sum of y+z+w is ranges from 0.8 to 1.2 (in a particular instance the sum of y+z+w was equal to 1), w is from 0 to 0.5, y and z are both greater than zero, and the ratio z/y ranges from 0 to 0.5 (in one instance the ratio of z/y was 0.1).

In some embodiments of the general formula of LiₓNi_{y}Co_{z}M_{w}O₂, M comprises multiple elements selected from selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof. In a non-limiting example, M contains BeₐMg_{b}Ca_{c}, where a +b+c=w. M may be a in the form of M⁰ₐ, M⁰ₐM¹_{b}, or M⁰ₐM¹_{b}M²_{c}, where M⁰ M¹ and M² are elements selected from the group consisting of aluminum (Al), titanium (Ti), tungsten (W), chromium (Cr), molybdenum (Mo), magnesium (Mg), beryllium (Be), calcium (Ca), tantalum (Ta), and silicon (Si), wherein a +b+c=w. In some embodiments M_{w} comprises multiple elements and w is equal to the sum of M elements in the LiₓNi_{y}Co_{z}M_{w}O₂.

This class of cathode active material is generally related to lithium metal oxides containing nickel, cobalt, and a third element, typically a metal (M). It may be noted that if M is not a metal with a valence state of +3 (e.g., magnesium, beryllium, and calcium with a valence state of +2, or silicon with a valence of +4), the sum of y+z+w may deviate somewhat from 1. For metals of valence +2, such as magnesium, beryllium, and calcium, the sum will be slightly larger than 1 in order to balance the −4 charge on the two oxygen atoms. For elements of valence +4, such as silicon, the sum will be slightly less than 1.

In general, these compounds have the layered structure of α-NaCrO₂ crystals, wherein lithium ions can move through the lattice rapidly, along the lattice planes. This structure is also found in LiCoO₂ and LiNiO₂, which are a significantly different structure than the LiMn₂O₄ spinnel structure. Further, these compounds have a significantly greater variation in potential with state of charge (i.e., sloping discharge profile) than the corresponding simple oxides, particularly LiCoO₂. The element nickel appears to impart a very high capacity to these compounds. Depending upon the relative amounts of cobalt and other metals in the compound, any given compound may have a reversible capacity in the range from 180 to 215 mAh/g. For comparison, LiCoO₂ has an observed capacity of about 139-148 mAh/g and LiMn₂O₄ has an observed capacity of about 120-148 mAh/g. Cobalt appears to be capable of improving the stability of the compound by holding other transition metal atoms, especially nickel, in place within the lattice.

The presence of the third element (M) in the lattice is believed to be able to improve cell safety on overcharge. The lithium metal oxides, particularly lithium nickel oxide, may undergo exothermic decomposition with the release of oxygen on overcharge. This and other detrimental overcharge reactions may be reduced if the lithium metal oxide compound becomes non-conductive in a highly delithiated state. Further, fast dissipation of heat generated during cell operations or overcharge could assist in preventing the exothermic degradation of the material and the electrolyte. This latter effect may be accomplished by embracing the cathode active material particles with graphene sheets that have a high thermal conductivity.

A particularly desired class of cathode materials contains M being selected from Be, Mg, Ca and their various combinations and their combinations with Mn (manganese) and/or Al (aluminum). The present of these elements appear to impact cycling stability to the lithium-ion cells containing these cathode active materials.

Compounds having the formula LiₓNi_{y}Co_{z}M_{w}O₂ may be prepared by high temperature solid state reactions in the following. The process typically begins with mixing a desired lithium-containing compound, a specified element M-containing compound (e.g., Al, Mg, Be, Ca, etc.), a cobalt-containing compound, and a nickel-containing compound. The various components are homogeneously mixed and then thermally reacted at a temperature of between about 500° C. and 1300° C. For many compounds, the preferred reaction temperature is between about 600° C. and 1000° C., and most preferably between about 750° C. and 850° C. Further, the reaction is preferably conducted in an atmosphere of flowing air or, more preferably, flowing oxygen.

The desired lithium-containing compound may be any one or more of lithium nitrate (LiNO₃), lithium hydroxide (LiOH), lithium acetate (LiO₂CCH₃), and lithium carbonate (Li₂CO₃), for example. The cobalt-containing compound may be any one or more of cobalt metal, cobalt oxide (Co₃O₄ or CoO), cobalt carbonate (CoCO₃), cobalt nitrate (Co(NO₃)₂), cobalt hydroxide (Co(OH)₂), and cobalt acetate (Co(O₂CCH₃)₂), for example. The nickel containing compound may be any one or more of nickel metal, nickel oxide (NiO), nickel carbonate (NiCO₃), nickel acetate (Ni(O₂CCH₃)₂), and nickel hydroxide (Ni(OH)₂), for example. If the M-containing compound is to provide aluminum, this compound may be selected from any one or more of aluminum hydroxide (Al(OH)₃), aluminum oxide (A₂O₃), aluminum carbonate (Al₂(CO₃)₃), and aluminum metal, for example. Other M-containing materials may be employed to provide non-aluminum containing materials such as magnesium oxide (MgO), beryllium oxide (BeO), calcium oxide (CaO), metal calcium (Ca), molybdenum oxide (MoO₃), titanium oxide (TiO₂), tungsten oxide (WO₂), chromium metal, chromium oxide (CrO₃ or Cr₂O₃), tantalum oxide (Ta₂O₄ or Ta₂O₅), etc.

Alternatively, one may simply combine the simple lithium oxides of the metals and heat-treat the mixture to form the final compound. This process entails combining lithium cobalt oxide, lithium nickel oxide, and a lithium metal oxide of the formula LiMO₂, where M is preferably magnesium, aluminum, chromium, or titanium. For instance, in order to obtain LiNi_{0.6}Co_{0.15}Al_{0.25}O₂, metal oxides, including LiNiO₂, LiCoO₂, and LiAlO₂, could be mixed in a 60:15:25 molar ratio. The resulting mixture is then reacted at high temperatures as described above.

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In other words, graphene planes (hexagonal lattice structure of carbon atoms) constitute a significant portion of a graphite particle.

A graphene sheet or nano graphene platelet (NGP) is essentially composed of a sheet of graphene plane or multiple sheets of graphene plane stacked and bonded together (typically, on an average, less than 10 sheets per multi-layer platelet). Each graphene plane, also referred to as a graphene sheet or a hexagonal basal plane, comprises a two-dimensional hexagonal structure of carbon atoms. Each platelet has a length and a width parallel to the graphene plane and a thickness orthogonal to the graphene plane. A single-sheet graphene is as thin as 0.34 nm. A few-layer graphene sheet contains 2-10 graphene planes stacked together. The length and width of a NGP are typically between 200 nm and 20 μm, but could be longer or shorter, depending upon the sizes of source graphite material particles.

Our research group pioneered the development of graphene materials and related production processes as early as 2002: (1) B. Z. Jang and W. C. Huang, “Nano-scaled Graphene Plates,” U.S. Pat. No. 7,071,258 (Jul. 4, 2006), application submitted on Oct. 21, 2002; (2) B. Z. Jang, et al. “Process for Producing Nano-scaled Graphene Plates,” U.S. patent application Ser. No. 10/858,814 (Jun. 3, 2004) (U.S. Pat. Pub. No. 2005/0271574) (now abandoned); and (3) B. Z. Jang, A. Zhamu, and J. Guo, “Process for Producing Nano-scaled Platelets and Nanocomposites,” U.S. patent application Ser. No. 11/509,424 (Aug. 25, 2006) (U.S. Pat. Pub. No. 2008/0048152) (now abandoned).

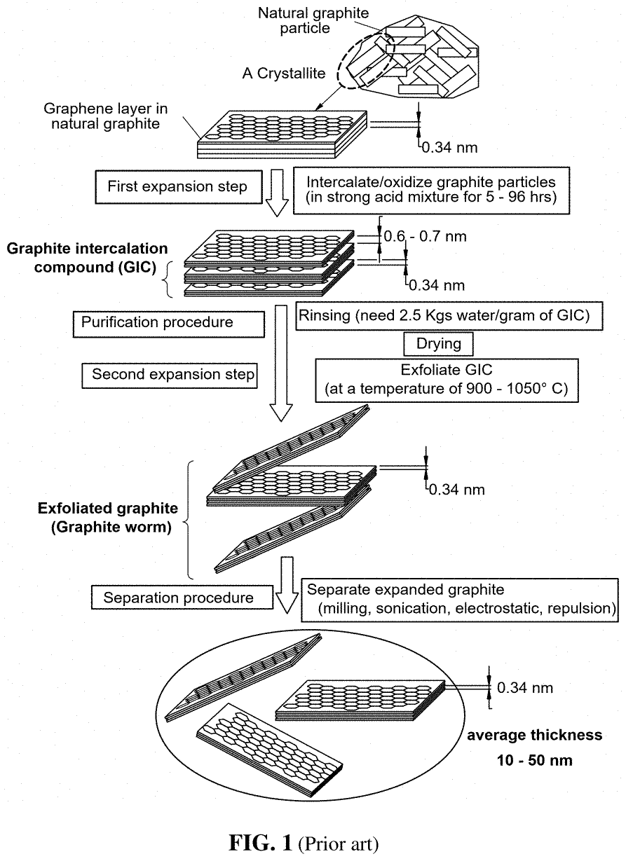

A highly useful approach (FIG. 1) entails treating natural graphite powder with an intercalant and an oxidant (e.g., concentrated sulfuric acid and nitric acid, respectively) to obtain a graphite intercalation compound (GIC) or, actually, graphite oxide (GO). [William S. Hummers, Jr., et al., Preparation of Graphitic Oxide, Journal of the American Chemical Society, 1958, p. 1339.] Prior to intercalation or oxidation, graphite has an inter-graphene plane spacing of approximately 0.335 nm (L_{d}=½ d₀₀₂=0.335 nm). With an intercalation and oxidation treatment, the inter-graphene spacing is increased to a value typically greater than 0.6 nm. This is the first expansion stage experienced by the graphite material during this chemical route. The obtained GIC or GO is then subjected to further expansion (often referred to as exfoliation) using either a thermal shock exposure or a solution-based, ultrasonication-assisted graphene layer exfoliation approach.

It may be noted that if natural graphite powder is dispersed in an oxidant (e.g., a mixture of concentrated sulfuric acid and nitric acid or potassium permanganate) for a sufficient period of time one can obtain a GO material having an oxygen content greater than 30% by weight (preferably >35%, typically up to about 50%), which can be formed into a GO gel state via water rinsing and mechanical shearing.

In the thermal shock exposure approach, the GIC or GO is exposed to a high temperature (typically 800-1,050° C.) for a short period of time (typically 15 to 60 seconds) to exfoliate or expand the GIC or GO for the formation of exfoliated or further expanded graphite, which is typically in the form of a “graphite worm” composed of graphite flakes that are still interconnected with one another. This thermal shock procedure can produce some separated graphite flakes or graphene sheets, but normally the majority of graphite flakes remain interconnected. Typically, the exfoliated graphite or graphite worm is then subjected to a flake separation treatment using air milling, mechanical shearing, or ultrasonication in water. Hence, approach 1 basically entails three distinct procedures: first expansion (oxidation or intercalation), further expansion (or “exfoliation”), and separation.

In the solution-based separation approach, the expanded or exfoliated GO powder is dispersed in water or aqueous alcohol solution, which is subjected to ultrasonication. It is important to note that in these processes, ultrasonification is used after intercalation and oxidation of graphite (i.e., after first expansion) and typically after thermal shock exposure of the resulting GIC or GO (after second expansion). Alternatively, the GO powder dispersed in water is subjected to an ion exchange or lengthy purification procedure in such a manner that the repulsive forces between ions residing in the inter-planar spaces overcome the inter-graphene van der Waals forces, resulting in graphene layer separations.

In the aforementioned examples, the starting material for the preparation of graphene sheets or NGPs is a graphitic material that may be selected from the group consisting of natural graphite, artificial graphite, graphite oxide, graphite fluoride, graphite fiber, carbon fiber, carbon nano-fiber, carbon nano-tube, mesophase carbon micro-bead (MCMB) or carbonaceous micro-sphere (CMS), soft carbon, hard carbon, and combinations thereof.

Graphite oxide may be prepared by dispersing or immersing a laminar graphite material (e.g., powder of natural flake graphite or synthetic graphite) in an oxidizing agent, typically a mixture of an intercalant (e.g., concentrated sulfuric acid) and an oxidant (e.g., nitric acid, hydrogen peroxide, sodium perchlorate, potassium permanganate) at a desired temperature (typically 0-70° C.) for a sufficient length of time (typically 4 hours to 5 days). The resulting graphite oxide particles are then rinsed with water several times to adjust the pH values to typically 2-5. The resulting suspension of graphite oxide particles dispersed in water is then subjected to ultrasonication to produce a dispersion of separate graphene oxide sheets dispersed in water. A small amount of reducing agent (e.g. Na₄B) may be added to obtain reduced graphene oxide (RGO) sheets.

In order to reduce the time required to produce a precursor solution or suspension, one may choose to oxidize the graphite to some extent for a shorter period of time (e.g., 30 minutes-4 hours) to obtain graphite intercalation compound (GIC). The GIC particles are then exposed to a thermal shock, preferably in a temperature range of 600-1,100° C. for typically 15 to 60 seconds to obtain exfoliated graphite or graphite worms, which are optionally (but preferably) subjected to mechanical shearing (e.g. using a mechanical shearing machine or an ultrasonicator) to break up the graphite flakes that constitute a graphite worm. Either the already separated graphene sheets (after mechanical shearing) or the un-broken graphite worms or individual graphite flakes are then re-dispersed in water, acid, or organic solvent and ultrasonicated to obtain a graphene dispersion.

The pristine graphene material is preferably produced by one of the following three processes: (A) Intercalating the graphitic material with a non-oxidizing agent, followed by a thermal or chemical exfoliation treatment in a non-oxidizing environment; (B) Subjecting the graphitic material to a supercritical fluid environment for inter-graphene layer penetration and exfoliation; or (C) Dispersing the graphitic material in a powder form to an aqueous solution containing a surfactant or dispersing agent to obtain a suspension and subjecting the suspension to direct ultrasonication to obtain a graphene dispersion.

In Procedure (A), a particularly preferred step comprises (i) intercalating the graphitic material with a non-oxidizing agent, selected from an alkali metal (e.g., potassium, sodium, lithium, or cesium), alkaline earth metal, or an alloy, mixture, or eutectic of an alkali or alkaline metal; and (ii) a chemical exfoliation treatment (e.g., by immersing potassium-intercalated graphite in ethanol solution).

In Procedure (B), a preferred step comprises immersing the graphitic material to a supercritical fluid, such as carbon dioxide (e.g., at temperature T >31° C. and pressure P >7.4 MPa) and water (e.g., at T >374° C. and P >22.1 MPa), for a period of time sufficient for inter-graphene layer penetration (tentative intercalation). This step is then followed by a sudden de-pressurization to exfoliate individual graphene layers. Other suitable supercritical fluids include methane, ethane, ethylene, hydrogen peroxide, ozone, water oxidation (water containing a high concentration of dissolved oxygen), or a mixture thereof.

In Procedure (C), a preferred step comprises (a) dispersing particles of a graphitic material in a liquid medium containing therein a surfactant or dispersing agent to obtain a suspension or slurry; and (b) exposing the suspension or slurry to ultrasonic waves (a process commonly referred to as ultrasonication) at an energy level for a sufficient length of time to produce a graphene dispersion of separated graphene sheets (non-oxidized NGPs) dispersed in a liquid medium (e.g. water, alcohol, or organic solvent).

Graphene materials can be produced with an oxygen content no greater than 25% by weight, preferably below 20% by weight, further preferably below 5%. Typically, the oxygen content is between 5% and 20% by weight. The oxygen content can be determined using chemical elemental analysis and/or X-ray photoelectron spectroscopy (XPS). When the oxygen content of graphene oxide exceeds 30% by weight (more typically when >35%), the GO molecules dispersed or dissolved in water for a GO gel state.

The laminar graphite materials used in the prior art processes for the production of the GIC, graphite oxide, and subsequently made exfoliated graphite, flexible graphite sheets, and graphene platelets were, in most cases, natural graphite. However, the present disclosure is not limited to natural graphite. The starting material may be selected from the group consisting of natural graphite, artificial graphite (e.g., highly oriented pyrolytic graphite, HOPG), graphite oxide, graphite fluoride, graphite fiber, carbon fiber, carbon nano-fiber, carbon nano-tube, mesophase carbon micro-bead (MCMB) or carbonaceous micro-sphere (CMS), soft carbon, hard carbon, and combinations thereof. All of these materials contain graphite crystallites that are composed of layers of graphene planes stacked or bonded together via van der Waals forces. In natural graphite, multiple stacks of graphene planes, with the graphene plane orientation varying from stack to stack, are clustered together. In carbon fibers, the graphene planes are usually oriented along a preferred direction. Generally speaking, soft carbons are carbonaceous materials obtained from carbonization of liquid-state, aromatic molecules. Their aromatic ring or graphene structures are more or less parallel to one another, enabling further graphitization. Hard carbons are carbonaceous materials obtained from aromatic solid materials (e.g., polymers, such as phenolic resin and polyfurfuryl alcohol). Their graphene structures are relatively randomly oriented and, hence, further graphitization is difficult to achieve even at a temperature higher than 2,500° C. But, graphene sheets do exist in these carbons.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual single graphene layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultra-sonic treatment of a graphite fluoride in a liquid medium to produce graphene fluoride sheets dispersed in the liquid medium. The resulting dispersion can be directly used in the graphene deposition of polymer component surfaces.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

For the purpose of defining the claims of the instant application, NGPs or graphene materials include discrete sheets/platelets of single-layer and multi-layer (typically less than 10 layers, the few-layer graphene) pristine graphene, graphene oxide, reduced graphene oxide (RGO), graphene fluoride, graphene chloride, graphene bromide, graphene iodide, hydrogenated graphene, nitrogenated graphene, chemically functionalized graphene, doped graphene (e.g. doped by B or N). Pristine graphene has essentially 0% oxygen. RGO typically has an oxygen content of 0.001%-5% by weight. Graphene oxide (including RGO) can have 0.001%-50% by weight of oxygen. Other than pristine graphene, all the graphene materials have 0.001%-50% by weight of non-carbon elements (e.g. O, H, N, B, F, Cl, Br, I, etc.). These materials are herein referred to as non-pristine graphene materials. The presently invented graphene can contain pristine or non-pristine graphene and the invented method allows for this flexibility. These graphene sheets all can be chemically functionalized.

In some situations, where graphene sheets have been previously made, but the cathode active materials remain in their precursor state (having been made yet), the process comprises (a) dispersing multiple sheets of a graphene material and a precursor (e.g. a mixture of lithium oxides of the metals, Ni and Co, and M) to a cathode active material (LiₓNi_{y}Co_{z}M_{w}O₂) in a liquid medium to form a suspension; (b) drying the suspension using a procedure of spray-drying, spray-pyrolysis, fluidized-bed drying, ultrasonic spraying, aerosol spraying, or liquid atomization to form a precursor particulate containing graphene sheets and particles or coating of the cathode active material precursor; and (c) thermally and/or chemically converting the precursor particulate to form the graphene-embraced particulate. The step of converting may comprise a procedure of chemically or thermally reducing the graphene precursor to reduce or eliminate oxygen content and other non-carbon elements of said graphene precursor.

Once both the graphene sheets and the desired cathode active materials (LiₓNi_{y}Co_{z}M_{w}O₂) are made, one can then produce the desired graphene-encapsulated cathode active materials by using any of the known micro-encapsulation methods. In certain embodiments, the process comprises (a) dispersing multiple sheets of a graphene material and multiple particles of a cathode active material in a liquid medium to form a suspension; (b) dispensing the suspension into micro-droplets and removing the liquid medium to form the desired particulates.

There are three broad categories of micro-encapsulation methods that can be implemented to produce particulates of graphene shell-encapsulated core comprising possibly some internal graphene sheets and particles of a cathode active material. These include physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization.

Pan-Coating Method:

The pan coating process involves tumbling a mixture of graphene sheets, particles of a cathode active material, and an optional conductive additive in a pan or a similar device while the encapsulating material (e.g. graphene sheets dispersed in a monomer/oligomer, polymer melt, polymer/solvent solution) is applied slowly until a desired encapsulating shell thickness is attained.

Air-Suspension Coating Method:

In the air suspension coating process, a mixture of graphene sheets, particles of a cathode active material, and an optional conductive additive is dispersed into the supporting air stream in an encapsulating chamber. A controlled stream of a suspension comprising graphene sheets dispersed in a polymer-solvent solution (e.g. polymer or its monomer or oligomer dissolved in a solvent; or its monomer or oligomer alone in a liquid state) is concurrently introduced into this chamber, allowing the solution to hit and coat the suspended mixture particles. These suspended particles are encapsulated (fully coated) with polymer/graphene sheets while the volatile solvent is removed, leaving a thin layer of polymer-bonded graphene sheets on surfaces of the core. This process may be repeated several times until the required parameters, such as full-coating thickness (i.e. encapsulating shell or wall thickness), are achieved.

Centrifugal Extrusion:

Cathode active particles may be encapsulated with a polymer/graphene shell using a rotating extrusion head containing concentric nozzles. In this process, a stream of core fluid (slurry containing cathode active particles dispersed in a solvent) is surrounded by a sheath of shell solution or melt containing graphene sheets dispersed therein. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry.

Vibrational Nozzle Encapsulation Method:

Core-shell encapsulation or matrix-encapsulation of graphene sheets and cathode active particles can be conducted using a laminar flow through a nozzle and vibration of the nozzle or the liquid. The vibration has to be done in resonance with the Rayleigh instability, leading to very uniform droplets. The liquid can consist of any liquids with limited viscosities (1-50,000 mPa·s): emulsions, suspensions or slurry containing the cathode active material particles and the graphene sheets dispersed in a liquid medium.

Spray-Drying:

Spray drying may be used to encapsulate cathode active particles graphene sheets (with or without a polymer) when the graphene sheets and cathode active particles are suspended in a liquid medium to form a suspension. In spray drying, the liquid feed (solution or suspension) is atomized to form droplets which, upon contacts with hot gas, allow solvent to get vaporized and a graphene-based shell to fully embrace the cathode active material particles and some internal graphene sheets.

In-Situ Polymerization:

In some micro-encapsulation processes, cathode active particles are fully coated with a graphene sheet-containing monomer or oligomer first. Then, direct polymerization of the monomer or oligomer is carried out on the surfaces of these material particles.

One preferred specific embodiment of the present disclosure is a method of peeling off graphene planes (or graphene sheets) from graphitic particle surfaces and directly transferring these graphene sheets to surfaces of cathode active material particles (the primary particles). This disclosure provides a strikingly simple, fast, scalable, environmentally benign, and cost-effective process that avoids essentially all of the drawbacks associated with prior art processes of producing graphene sheets and obviates the need to execute a separate (additional) process to combine the produced graphene sheets and particles of an electrode active material together to form a composite or hybrid electrode active material.

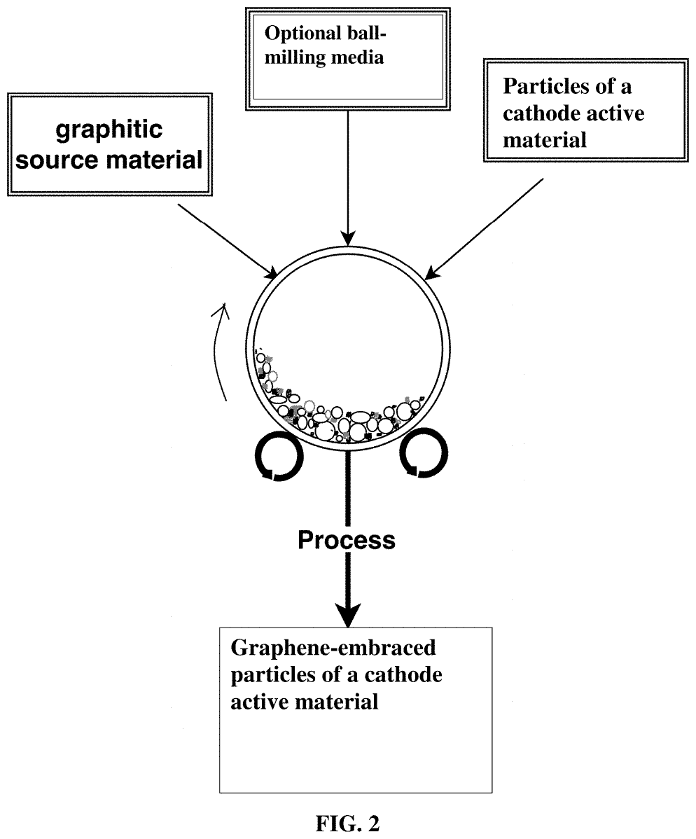

As schematically illustrated in FIG. 2, one preferred embodiment of this method entails placing particles of a source graphitic material and particles of a solid cathode active material (without any externally added impacting balls, such as ball-milling media) in an impacting chamber. After loading, the resulting mixture is exposed to impacting energy, which is accomplished, for instance, by rotating the chamber to enable the impacting of the active material particles against graphite particles. These repeated impacting events (occurring in high frequencies and high intensity) act to peel off graphene sheets from the surfaces of graphitic material particles and, immediately and directly, transfer these graphene sheets to the surfaces of the cathode active material particles to form graphene-embraced active material particles. Typically, the entire particle is covered by graphene sheets (fully wrapped around, embraced or encapsulated). This is herein referred to as the “direct transfer” process.

Alternatively but less desirably, impacting balls (e.g. stainless steel or zirconia beads) may be added into the impacting chambers and, as such, graphene sheets may also be peeled off by the impacting balls and tentatively transferred to the surfaces of these impacting balls first. When the graphene-coated impacting balls subsequently impinge upon the solid cathode active material particles, the graphene sheets are transferred to surfaces of the cathode active material particles to form graphene-coated cathode active material particles. This is an “indirect transfer” process. A drawback of such an indirect transfer process is the need to separate the externally added impacting balls (e.g. ball-milling media) from the graphene-embraced particles. This is not always possible or economically feasible, however.

In less than two hours (often less than 1 hour) of operating the direct transfer process, most of the constituent graphene sheets of source graphite particles are peeled off, forming mostly single-layer graphene and few-layer graphene (less than 10 graphene planes; mostly less than 5 layers or 5 graphene planes in the present study). Following the direct transfer process (graphene sheets wrapped around active material particles), the residual graphite particles (if present) are separated from the graphene-embraced (graphene-encapsulated) particles using a broad array of methods. Separation or classification of graphene-embraced (graphene-encapsulated) particles from residual graphite particles (if any) can be readily accomplished based on their differences in weight or density, particle sizes, magnetic properties, etc. The resulting graphene-embraced particles are already a two-component material; i.e. they are already “mixed” and there is no need to have a separate process of mixing isolated graphene sheets with electrode active material particles.

In other words, production of graphene sheets and coating of graphene sheets onto primary particle surfaces of electrode active materials are essentially accomplished concurrently in one operation. This is in stark contrast to the traditional processes of producing graphene sheets first and then subsequently mixing the graphene sheets with an active material. Traditional dry mixing typically does not result in homogeneous mixing or dispersion of two or multiple components. It is also challenging to properly disperse nano materials in a solvent to form a battery slurry mass for coating on a current collector, which is the most commonly used electrode production process for the lithium battery.

In the most common implementation of ball mill mixing, previously produced graphene sheets or platelets are added to electrode active material powders. Impact energy is applied via ball mill for a period of time to disperse graphene platelets or sheets in the powder. This is often carried out in a liquid (solvent) solution. The disadvantages of this graphene/active material mixing process are obvious—graphene is a costly input material, solvent recovery is required, and most significantly, the graphene input into the process has been damaged by oxidation during prior processing. This reduces desirable end properties, such as thermal conductivity and electrical conductivity.

Another prior art process is coating of CVD onto metal nano particles. This is the most limited of all prior art methods, being possible only on certain metals that are suitable catalysts for facilitating decomposition of hydrocarbon gas to form carbon atoms and as templates for graphene to grow on. As a “bottom up” graphene production method, it requires costly capital equipment and costly input materials.

In contrast, the presently invented impacting process entails combining graphene production, functionalization (if desired), and mixing of graphene sheets with electrode active material particles in a single operation. This fast and environmentally benign process not only avoids significant chemical usage, but also produces embracing graphene sheets of higher quality—pristine graphene as opposed to thermally reduced graphene oxide produced by the prior art process. Pristine graphene enables the creation of embraced particles with higher electrical and thermal conductivity.

Although the mechanisms remain incompletely understood, this revolutionary process of the present disclosure has essentially eliminated the conventionally required functions of graphene plane expansion, intercalant penetration, exfoliation, and separation of graphene sheets and replace it with a single, entirely mechanical exfoliation process. The whole process can take less than 2 hours (typically 10 minutes to 1 hour), and can be done with no added chemicals. This is absolutely stunning, a shocking surprise to even those top scientists and engineers or those of extraordinary ability in the art.

Another surprising result of the present study is the observation that a wide variety of carbonaceous and graphitic materials can be directly processed without any particle size reduction or pre-treatment. The particle size of graphite can be smaller than, comparable to, or larger than the particle size of the electrode active material primary particles. The graphitic material may be selected from natural graphite, synthetic graphite, highly oriented pyrolytic graphite, meso-carbon micro-bead, graphite fiber, graphitic nano-fiber, graphite oxide, graphite fluoride, chemically modified graphite, exfoliated graphite, or a combination thereof. It may be noted that the graphitic material used for the prior art chemical production and reduction of graphene oxide requires size reduction to 75 um or less in average particle size. This process requires size reduction equipment (for example hammer mills or screening mills), energy input, and dust mitigation. By contrast, the energy impacting device method can accept almost any size of graphitic material. A starting graphitic material of several mm or cm in size or larger or a starting material as small as nano-scaled has been successfully processed to create graphene-coated or graphene-embedded particles of cathode or anode active materials. The only size limitation is the chamber capacity of the energy impacting device; but this chamber can be very large (industry-scaled).

The presently invented process is capable of producing single-layer graphene sheets that completely wrap around the primary particles of an electrode active material. In many examples, the graphene sheets produced contain at least 80% single-layer graphene sheets. The graphene produced can contain pristine graphene, oxidized graphene with less than 5% oxygen content by weight, graphene fluoride, graphene oxide with less than 5% fluorine by weight, graphene with a carbon content of no less than 95% by weight, or functionalized graphene.

The energy impacting apparatus may be a vibratory ball mill, planetary ball mill, high energy mill, basket mill, agitator ball mill, cryogenic ball mill, micro ball mill, tumbler ball mill, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, or resonant acoustic mixer. The procedure of operating the energy impacting apparatus may be conducted in a continuous manner using a continuous energy impacting device.

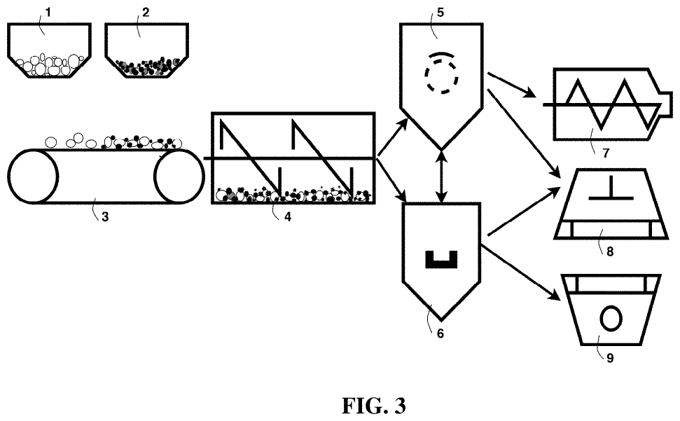

In a desired embodiment, the presently invented method is carried out in an automated and/or continuous manner. For instance, as illustrated in FIG. 3, the mixture of graphite particles 1 and electrode active material particles 2 is delivered by a conveyer belt 3 and fed into a continuous ball mill 4. After ball milling to form graphene-embraced particles, the product mixture (possibly also containing some residual graphite particles) is discharged from the ball mill apparatus 4 into a screening device (e.g. a rotary drum 5) to separate graphene-embraced particles from residual graphite particles (if any). This separation operation may be assisted by a magnetic separator 6 if the electrode active material is ferromagnetic (e.g. containing Fe, Co, Ni, or Mn-based metal in some desired electronic configuration). The graphene-embraced particles may be delivered into a powder classifier, a cyclone, and or an electrostatic separator. The particles may be further processed, if so desired, by melting 7, pressing 8, or grinding/pelletizing apparatus 9. These procedures can be fully automated. The process may include characterization or classification of the output material and recycling of insufficiently processed material into the continuous energy impacting device. The process may include weight monitoring of the load in the continuous energy impacting device to optimize material properties and throughput.

In some embodiments, prior to the graphene-encapsulating step, the particles of solid electrode active material contain particles that are pre-coated with a coating of a conductive material selected from carbon, pitch, carbonized resin, a conductive polymer, a conductive organic material, a metal coating, a metal oxide shell, or a combination thereof. The coating layer thickness is preferably in the range from 1 nm to 10 μm, preferably from 10 nm to 1 μm, and further preferably from 20 nm to 200 nm.

In some embodiments, the primary particles of solid electrode active material contain particles that are pre-coated with a carbon precursor material selected from a coal tar pitch, petroleum pitch, meso-phase pitch, polymer, organic material, or a combination thereof. Subsequently, the method further contains a step of heat-treating the precursor-coated electrode active material to convert the carbon precursor material to a carbon material. This procedure produces carbon-encapsulated cathode active material particles.

In some embodiments, the carbon precursor-coated cathode particles may be subjected to graphene encapsulation by any of the processes described above so that the carbon precursor material resides between surfaces of the solid cathode active material particles and the graphene sheets. The carbon material is coated on the surfaces of solid cathode active material particles and/or chemically bonds the graphene sheets together. The carbon material helps to completely seal off the embracing graphene sheets to prevent direct contact of the embraced cathode active material with liquid electrolyte, which otherwise can catalyze decomposition of the liquid electrolyte particularly at a high cell charge potential.

In some embodiments, the cathode active material particles include powder, flakes, beads, pellets, spheres, wires, fibers, filaments, discs, ribbons, or rods, having a diameter or thickness from 10 nm to 20 μm. Preferably, the diameter or thickness is from 1 μm to 100 μm.

The following examples serve to provide the best modes of practice for the present disclosure and should not be construed as limiting the scope of the disclosure:

### Example 1: Production of LiNi_{0.75} Al_{0.25} O₂ and LiNi_{0.75}Co_{0.05}Mg_{0.1}Al_{0.1}O₂ Particles

Particles of LiNi_{0.75} Al_{0.25} O₂ (as a prior art baseline material) was prepared by combining 1.05 moles of vacuum-dried LiNO₃ powder (100° C., 4 hours) with 1.0 mole of a mixture of NiO and Al(OH)₃ reactants at a molar ratio of 75/25 of Ni/Al. A good mix of the reactants was obtained by continuously rotating a plastic container containing the chemicals and some stainless steel balls on a machine at about 60 rpm for 1 hour. The resulting mixture was compressed into pellets in a press at 4500 lb/in². The pellets then were placed into an alumina crucible, and heated in a retort furnace (a) first under a flowing argon atmosphere at 400° C. for 4 hours (to safely remove NO₂ and other gaseous products), followed by (b) heating under a flowing oxygen atmosphere at 750° C. for 16 hours. The reacted pellets were then crushed, ground, and sieved to less than 63 μm, following by a washing step with deionized water and vacuum drying the powder (to remove any remaining water soluble reactants or unwanted products). Next, the powder was compressed into a pellet at 4500 lb/in², and heated a second time under flowing oxygen at 750° C. for 16 hours. The product was crushed, ground, and sieved to less than 32 μm. The regrinding and reheating process was performed to insure complete reaction of the reactants to form the product.

In a similar manner, particles of LiNi_{0.75}Co_{0.05}Mg_{0.1}Al_{0.1}O₂ were prepared by firstly mixing powders of LiNO₃, NiCO₃, CoCO₃, Mg(OH)₂, and Al(OH)₃ at a desired stoichiometric ratio to form a reaction mixture. The reaction mixture was then heated at 750° C. under an oxygen stream for 24 hours. The composition of the resulting mixed metal oxides was confirmed by using X-ray diffraction.

A portion of the LiNi_{0.75}Co_{0.05}Mg_{0.1}Al_{0.1}O₂ particles was then subjected to carbon encapsulation via polymer encapsulation of these particles using a pan coating procedure, followed by carbonization of the encapsulating polymer (polyvinyl alcohol or phenolic resin).

### Example 2: Production of LiNi_{0.8}Co_{0.05}Be_{0.05}Ca_{0.1}O₂ Particles

The LiNi_{0.8}Co_{0.05}Be_{0.05}Ca_{0.1}O₂ particles were synthesized by following a procedure similar to that in Example 1, with the exception that Mg(OH)₂ and Al(OH)₃ were replaced by Ca(OH)₂ and Be(OH)₂.

### Example 3: Production of LiNi_{y}Co_{z}Mg_{w}O₂

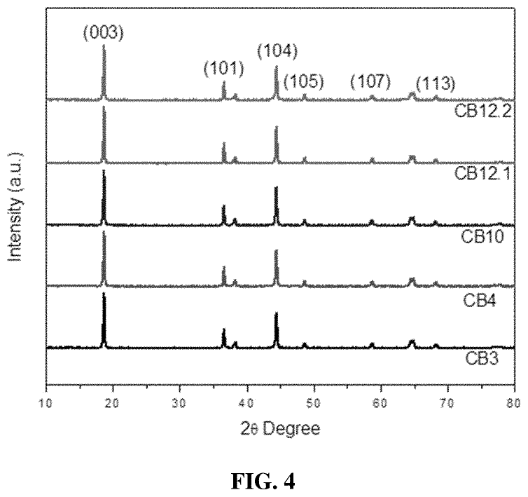

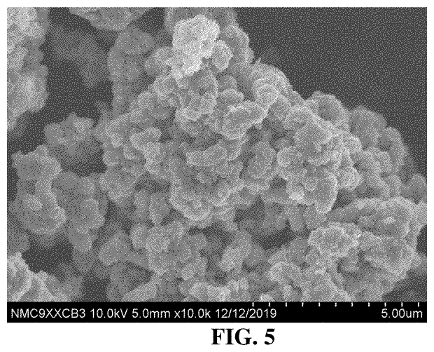

The synthesis of the Ni-rich cathode materials LiNi_{y}Co_{z}M_{w}O₂ (M=Mg) involved co-precipitation and calcination. In an experiment, for instance, two solutions were firstly prepared: (i) solution A, an aqueous mixture of NiSO₄.6H₂O, CoSO₄.7H₂O, and MgSO₄ in designed ratios; and (ii) solution B, an aqueous mixture of NaOH (0.5-2.0 M) and NH₄OH (0.5-1.3 M). Substantially equivalent amounts of solution A and solution B were simultaneously pumped into the reactor. The pH of the reactant solution was maintained at a value from 10 to 12. Nitrogen gas was introduced to avoid the oxidation of precursors. The required co-precipitation reaction time was approximately 5-24 hours. Then, the formed greenish NiₐCo_{b}Mg_{c}(OH)₂ precursor was filtered and washed repeatedly with deionized water until the pH of the filtrate was close to 7.0. The filtered powders were dried at 120° C. for 10 h. For the subsequent calcination process, the NiₐCo_{b}Mg_{c}(OH)₂ precursor was thoroughly mixed with LiOH.H₂O (molar ratio 1:1.02-1.10) using mortar and pre-calcinated at 500-550° C. for 5-10 h, followed by heating at 650-800° C. for 12-24 h with flowing oxygen gas. X-ray diffraction curves of several samples herein produced are shown in FIG. 4. Shown in FIG. 5 is an SEM image of the cathode active material particles herein produced.

### Example 4: Graphene Embraced Particles of Carbon-Embraced or Un-Coated Cathode Active Materials

Several types of cathode active materials in a fine powder form, including those described in Examples 1-3, were encapsulated by graphene sheets by several methods. In one method (direct transfer method), 1 kg of cathode active material powder and 100 grams of natural flake graphite, 50 mesh (average particle size 0.18 mm; Asbury Carbons, Asbury N.J.) were placed in a high-energy ball mill container. The ball mill was operated at 300 rpm for 0.5 to 4 hours. The container lid was then removed and particles of the cathode active materials were found to be fully coated (embraced or encapsulated) with a dark layer, which was verified to be graphene by Raman spectroscopy. The mass of processed material was placed over a 50 mesh sieve and, in some cases, a small amount of unprocessed flake graphite was removed.

In a second method, the primary particles of LiNi_{y}Co_{z}Mg_{w}O₂ were dispersed in a graphene oxide (GO)/water suspension to obtain slurries having a solid content from approximately 0.5% to 20%. These slurries were then spray-dried to prepare secondary particles or particulates containing primary particles that are embraced with GO sheets. Some GO sheets were also found to be included in the core of the particulate. These particulates were thermally reduced at 300-700° C. under a H₂/N₂ flowing condition.

### Example 5: Production of Graphene-Embraced Cathode Particles

In an experiment, 2 grams of LiNi_{y}Co_{z}M_{w}O₂ powder and 0.25 grams highly oriented pyrolytic graphite (HOPG) were placed in a resonant acoustic mill and processed for 5 minutes. For comparison, the same experiment was conducted, but the milling container further contains zirconia milling beads. We were surprised to discover that the former process (cathode active material particles serving as the milling media per se without the externally added zirconia milling beads) led to particulates having fewer cathode active particles encapsulated by graphene sheets. Further, the encapsulating shell tends to have single-layer graphene sheets.

In contrast, externally added milling beads tend to lead to larger particulates having multi-layer graphene sheets embracing the cathode active material particles.

### Example 6: Graphene Encapsulation Via Direct Transfer Vs. Chemical Production of Graphene Sheets Plus Freezer Milling

In a separate experiment, 10 grams of LiNi_{y}Co_{z}M_{w}O₂ powder and 1 gram of reduced graphene oxide sheets (produced with the Hummer's method explained below) were placed in a freezer mill and processed for 10 minutes, enabling encapsulation of cathode active material particles by the reduced graphene oxide sheets. In this experiment, graphite oxide as prepared by oxidation of graphite flakes with sulfuric acid, nitrate, and permanganate according to the method of Hummers [U.S. Pat. No. 2,798,878, Jul. 9, 1957]. Upon completion of the reaction, the mixture was poured into deionized water and filtered. The graphite oxide was repeatedly washed in a 5% solution of HCl to remove the majority of the sulfate ions. The sample was then washed repeatedly with deionized water until the pH of the filtrate was neutral. The slurry was spray-dried and placed in a vacuum oven at 60° C. for 24 hours. The interlayer spacing of the resulting laminar graphite oxide was determined by the Debey-Scherrer X-ray technique to be approximately 0.73 nm (7.3 Å). A sample of this material was subsequently transferred to a furnace pre-set at 650° C. for 4 minutes for exfoliation and heated in an inert atmosphere furnace at 1200° C. for 4 hours to create a low density powder comprised of few layer reduced graphene oxide (RGO). Surface area was measured via nitrogen adsorption BET.

The graphene sheets, once produced, tend to result in the formation of multiple-particle particulates that each contains a larger number of cathode active material particles embraced or encapsulated by graphene sheets, as compared to the direct-transfer process.

### Example 7: Preparation and Electrochemical Testing of Various Battery Cells

For most of the cathode active materials investigated, we prepared lithium-ion cells or lithium metal cells using the conventional slurry coating method. A typical anode composition includes 85 wt. % active material (e.g., graphene-encapsulated cathode particles), 7 wt. % acetylene black (Super-P), and 8 wt. % polyvinylidene fluoride binder (PVDF, 5 wt. % solid content) dissolved in N-methyl-2-pyrrolidine (NMP). After coating the slurries on Al foil, the electrodes were dried at 120° C. in vacuum for 2 h to remove the solvent. An anode layer (e.g. Li metal for a half cell test), a porous separator layer (e.g. Celgard 2400 membrane), and a cathode layer are then laminated together and housed in a plastic-Al envelop. The cell is then injected with 1 M LiPF₆ electrolyte solution dissolved in a mixture of ethylene carbonate (EC) and diethyl carbonate (DEC) (EC-DEC, 1:1 v/v). In some cells, ionic liquids were used as the liquid electrolyte. The cell assemblies were made in an argon-filled glove-box.

The cyclic voltammetry (CV) measurements were carried out using an Arbin electrochemical workstation at a typical scanning rate of 1 mV/s. In addition, the electrochemical performances of various cells were also evaluated by galvanostatic charge/discharge cycling at a current density of from 50 mA/g to 10 A/g.

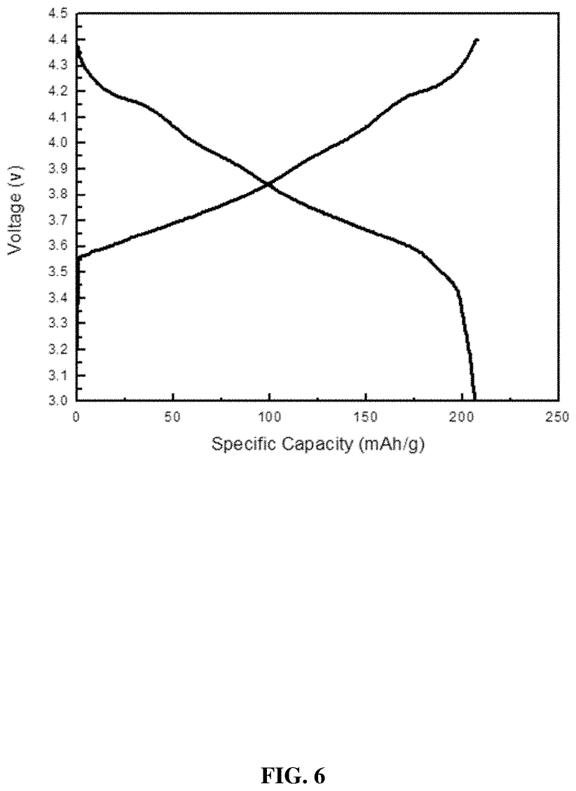

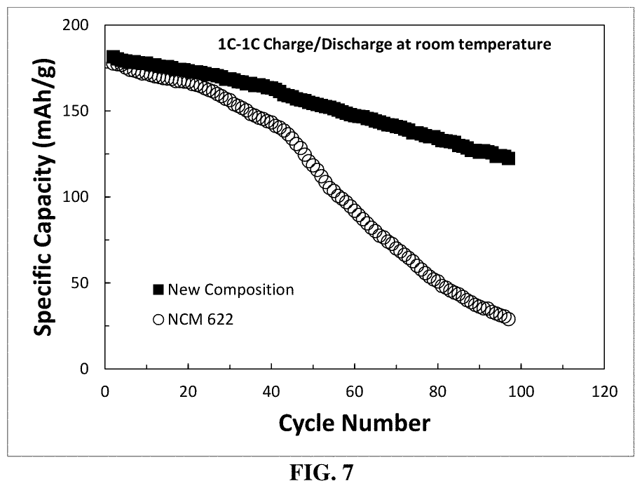

FIG. 6 shows the charge-discharge curves of a LiNi_{y}Co_{z}Mg_{w}O₂ material herein produced, indicating a specific capacity higher than 200 mAh/g. Shown in FIG. 7 are the discharge capacities of a LiNi_{y}Co_{z}Mg_{w}O₂ material and those of a conventional NCM-622 cathode material plotted as a function of charge/discharge cycle number. These data have demonstrated that the presently disclosed cathode active material is superior to the most widely used cathode active materials in terms of cycling stability. We have further observed that the presence of a graphene-based encapsulating shell can significantly improve the rate capability of the cathode active materials. These cathode particulates, when tested under higher charge/discharge rates, exhibit higher specific capacities as compared to the corresponding cathode particles without graphene encapsulation.

1. A graphene-embraced particulate for use as a lithium-ion battery cathode active material, said particulate comprising a core of one or a plurality of particles of a cathode active material embraced or encapsulated by a shell comprising multiple graphene sheets, wherein the cathode active material is selected from the group of lithium cobalt metal oxides having a general formula LiₓNi_{y}Co_{z}M_{w}O₂, where M is selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof and x is from 0 to 1.2, the sum of y+z+w ranges from 0.8 to 1.2, w ranges from 0 to 0.5, y and z are both greater than zero, and the ratio z/y ranges from 0 to 0.5.

2. The graphene-embraced particulate of claim 1, wherein said graphene sheets comprise single-layer or few-layer graphene selected from pristine graphene, graphene oxide, reduced graphene oxide, graphene fluoride, graphene chloride, graphene bromide, graphene iodide, hydrogenated graphene, nitrogenated graphene, doped graphene, functionalized graphene, or a combination thereof.

3. The graphene-embraced particulate of claim 1, wherein said core further comprises a carbon material in electronic contact with said one or a plurality of cathode active material particles.

4. The graphene-embraced particulate of claim 3, wherein the carbon material in the core is selected from an amorphous carbon coating deposited on surfaces of said one or a plurality of particles of a cathode active material, a carbon particle, graphite flake, graphene sheet (internal graphene sheet), carbon nanotube, carbon nano-fiber, carbon black, acetylene black, carbonized resin, or a combination thereof.

5. The graphene-embraced particulate of claim 1 wherein the graphene amount is from 0.01% to 20% by weight of the total weight of graphene and the cathode active material combined.

6. The graphene-embraced particulate of claim 1 wherein said particulate has an electrical conductivity greater than 10⁻⁴ S/cm.

7. The graphene-embraced particulate of claim 1 wherein said particulate is substantially spherical or ellipsoidal in shape.

8. The graphene-embraced particulate of claim 1, wherein said cathode active material particles in said particulate have a dimension smaller than 1 μm.

9. The graphene-embraced particulate of claim 1, wherein said cathode active material particles in said particulate have a dimension smaller than 100 nm.

10. A carbon-embraced particulate for use as a lithium-ion battery cathode active material, said particulate comprising a core of one or a plurality of particles of a cathode active material embraced or encapsulated by a shell comprising an encapsulating carbon material, wherein the cathode active material is selected from the group of lithium cobalt metal oxides having a general formula LiₓNi_{y}Co_{z}M_{w}O₂, where M is selected from the group consisting of aluminum (Al), titanium (Ti), tungsten (W), chromium (Cr), molybdenum, magnesium, beryllium (Be), calcium (Ca), tantalum (Ta), silicon (Si), and combinations thereof and x is from 0 to 1.2, the sum of y+z+w ranges from 0.8 to 1.2, w is from 0 to 0.5, y and z are both greater than zero, and the ratio z/y ranges from 0 to 0.5, wherein M_{w} comprises multiple elements and w is the sum of M_{w} elements.

11. The carbon-embraced particulate of claim 10, wherein said encapsulating carbon material is selected from amorphous carbon, chemical vapor deposition carbon, physical vapor deposition carbon, sputtering carbon, carbonized resin or polymeric carbon, or a combination thereof.

12. The carbon-embraced particulate of claim 10, wherein said core further comprises a carbon or graphitic material selected from a carbon particle, graphite flake, graphene sheet, carbon nanotube, carbon nano-fiber, carbon black, acetylene black, carbonized resin, or a combination thereof.

13. A process for producing the graphene-embraced particulate of claim 1, said process comprising:
a. Dispersing multiple sheets of a graphene material and a precursor to a cathode active material in a liquid medium to form a suspension;
b. drying said suspension using a procedure of spray-drying, spray-pyrolysis, fluidized-bed drying, ultrasonic spraying, aerosol spraying, or liquid atomization to form a precursor particulate containing graphene sheets and particles or coating of said cathode active material precursor; and
c. thermally and/or chemically converting said precursor particulate to form said graphene-embraced particulate.

14. The process of claim 13, wherein said step of converting comprises a procedure of chemically or thermally reducing said graphene precursor to reduce or eliminate oxygen content and other non-carbon elements of said graphene precursor.

15. A process for producing a mass of graphene-embraced particulates as defined in claim 1, said process comprising:
a) mixing multiple particles of a graphitic material and multiple primary particles of said solid cathode active material and optional ball-milling media to form a mixture in an impacting chamber of an energy impacting apparatus;
b) operating said energy impacting apparatus with a frequency and an intensity for a length of time sufficient for peeling off graphene sheets from said particles of graphitic material and transferring said peeled graphene sheets to surfaces of said primary particles of said solid cathode active material and fully embrace or encapsulate said primary particles to produce graphene-embraced or graphene-encapsulated primary particles of said cathode active material inside said impacting chamber; and
c) recovering said graphene-embraced or graphene-encapsulated cathode active material particles from said impacting chamber.

16. The process of claim 15, further comprising a step of incorporating said mass of graphene-embraced particulates into a battery cathode electrode.

17. The process of claim 15, wherein said primary particles of cathode active material contain particles pre-coated with a layer of conductive material selected from a carbon, pitch, carbonized resin, conductive polymer, conductive organic material, metal coating, metal oxide shell, or a combination thereof.

18. The process of claim 15, wherein said primary particles of solid cathode active material contain particles pre-coated with a carbon precursor material prior to step (a), wherein said carbon precursor material is selected from a coal tar pitch, petroleum pitch, meso-phase pitch, polymer, organic material, or a combination thereof so that said carbon precursor material resides between surfaces of said primary particles of solid cathode active material and said sheets of graphene material, and said process further contains a step of heat-treating said graphene-embraced primary particles of cathode active material to convert said carbon precursor material to a carbon material and said sheets of graphene material and said carbon material is coated on said surfaces of said primary particles of cathode active material and/or chemically bonds said graphene sheets together.

19. The process of claim 15, wherein said graphitic material is selected from natural graphite, synthetic graphite, highly oriented pyrolytic graphite, graphite fiber, graphitic nano-fiber, graphite fluoride, chemically modified graphite, meso-carbon micro-bead, partially crystalline graphite, or a combination thereof.

20. The process of claim 15, wherein the energy impacting apparatus is a vibratory ball mill, planetary ball mill, high energy mill, basket mill, agitator ball mill, cryogenic ball mill, micro ball mill, tumbler ball mill, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, or resonant acoustic mixer.

21. The process of claim 15, wherein said graphene sheets contain single-layer graphene sheets.

22. The process of claim 15, wherein said procedure of operating said energy impacting apparatus is conducted in a continuous manner using a continuous energy impacting device.
